(19) United States
(12) Patent Application Publication
(10) Pub. No.: US 2026/0286038 A1
(43) Pub. Date: Sep. 24, 2026

(54) POLYOL COMPOSITIONS AND USES THEREOF IN POLYURETHANE FOAMS

(71) Applicant: L&P Property Management Company, Carthage, MO (US)

(72) Inventor: Bruce W. Peterson, Jacksonville Beach, FL (US)

(21) Appl. No.: 19/568,081

(22) Filed: Mar. 16, 2026

Related U.S. Application Data
(60) Provisional application No. 63/773,710, filed on Mar. 18, 2025.

(51) Int. Cl. C08G 18/67; C08G 18/18; C08G 18/24; C08G 18/76; C08L 75/04

(52) U.S. Cl. CPC C08G 18/675; C08G 18/18; C08G 18/244; C08G 18/7671; C08L 75/04; C08G 2110/0083; C08L 2203/14

(57) ABSTRACT

The invention relates to a polyol composition for use in preparing a flexible polyurethane foam and the foam produced using the polyol composition. The composition comprises a naturally derived polyol in combination with a synthetic polyol of high molecular weight.

### FIELD OF THE INVENTION

The invention relates to polyurethane foam compositions and polyol materials used to produce polyurethane foam.

### BACKGROUND OF THE INVENTION

Polyurethane (PU) polymers, and particularly foams, have traditionally been prepared by reacting a diisocyanate with a dihydroxy (or a trihydroxy) polyol compound. Typically, to produce a polyether polyurethane foam, a diisocyanate is reacted with a polyol such as a polyether glycol. In the production of the foam, excess isocyanate groups in the polymer react with water or carboxylic acids to produce carbon dioxide. This gas introduces bubbles into the polymer material to produce the foam. Also, crosslinking is accomplished at this time. Depending on the specific polymer which is formed, and the type of crosslinking produced, the resulting foam will be either flexible or rigid. The resulting foam is a thermoset, due to the crosslinking.

The isocyanate used to react with the polyol can be 2,4-toluene diisocyanate, 2,6-toluene diisocyanate, polymeric diphenylmethane diisocyanate, 2,4-methylenediphenyl diisocyanate, 4,4′-methylenediphenyl diisocyanate, 4,4-benzidene diisocyanate, or 1,5-naphthalene diisocyanate, among others, and combinations thereof. In a polyurethane foam reaction, polyol(s) react with diisocyanate(s) forming polyurethane polymers, and typically with water, forming polyurea polymers and CO₂. To increase and control the rates of reaction, and thus rate of foam formation, catalysts are added. The flexible foam can be produced via a one-shot process, wherein the polyether intermediate, diisocyanate and catalysts are mixed just before foaming.

Flexible PU foam is typically produced in the form of slab stock via a continuous process, whereby the foam bun is up to about 8 feet wide and 3 to 5 feet high. The slab is cut into lengths of from about 5 to 200 feet, and then after a cure time of about 24 hours, the slab lengths are further cut for sale to users of the products.

One traditional polyol (dihydroxy or trihydroxy) is derived from petroleum sources. As used herein, such a polyol is identified as a synthetic polyol. Typical synthetic polyols used to produce a conventional slab-stock flexible foam have a molecular weight from about 3000 to about 3500. The nominal functionality of this typical synthetic polyol (number of free hydroxyl groups capable of undergoing reaction per molecule) is between 2.7 and 3.0.

Some portion of petroleum-based, or synthetic, reactants have been replaced in commercial PU products with materials derived from natural sources, such as those produced from plants. In particular, oils derived from certain plants serve as a renewable source which can be derivatized to produce a range of useful materials. Naturally-derived castor polyol obtained from castor beans can function as a polyol with an approximate molecular weight of about 1000 and a functionality of about 3. Naturally-derived soy polyol may be a reactant for foam production, but soy oil does not have active hydrogen atoms with which to react with an isocyanate. To convert to a soy polyol, at least one double-bonded oxygen on the molecule must be converted to a hydroxyl (—OH) group. This conversion step can be done completely whereby all three of the carbonyl groups on the soy oil molecule are converted to (—OH) groups, or only one or two of the three groups are converted. Naturally-derived polyols, identified herein as biopolyols, if used in place of various synthetic polyols, will produce PU foams having different properties. PU foams with a substantial renewable material content are in demand in part because of the environmental benefits associated with their ability to be categorized as a sustainable composition.

A biopolyol-containing PU foam may have an increased glass transition temperature (Tg). Higher levels of biopolyol in the PU foam typically result in increased stiffness of the foam, as well as deteriorated static and dynamic fatigue durability properties. Traditionally, castor and soy polyols have been used in the making of PU foams, but foams made with more than 15 percent of the total polyol being replaced with natural castor polyol (natural MW with no chain extension) or base MW soy polyol (soy polyol with hydroxyl groups added, but no chain extension) have shown generally unacceptable foam properties. As used herein, reference to the soy polyol encompasses a soy oil with conversion of at least one double-bonded oxygen to a hydroxyl (—OH) group. Such unacceptable foam properties include a collapse of the foam structure, large shift in the value for indentation force deflection (IFD), and increase in the compression set height loss, the latter two characteristics measured by appropriate ASTM testing (D3574). Compression set is also known as static fatigue, and the testing is typically carried out at 50%, 75% and 90% compression.

It is desirable to fashion a PU using a biopolyol with more acceptable physical properties at elevated levels of biopolyol content.

### SUMMARY OF THE INVENTION

It has been found that combining a castor or soy biopolyol with a high molecular weight synthetic polyol (herein referred to as HMW synthetic polyol), on the order of approximately 4500 to about 6500 MW with a functionality in the range of 2.5 to 3.0, in connection with formulating a polyurethane foam using an isocyanate, allows for increasing the biopolyol content of a PU foam and still being able to maintain acceptable performance parameters. In one embodiment, the use of the PU foam is to provide cushioning in bedding products, but the foam is also widely used in furniture, medical supports, floor cushioning, automotive seats and other interior upholstered parts, sports padding, and other cushioning. By employing the combination of biopolyol and HMW synthetic polyol, the maximum value of the bio-carbon, or sustainable carbon, content can be increased. This is considered a significant environmental advantage, and is commercially valuable due at least in part to the preference for using raw materials containing a quantity of bio-carbon in commercial formulations. Instead of a maximum amount of biopolyol in the polyol component of the PU foam of 15 pph (of the total polyol content by weight) before experiencing a foam performance drop-off, the biopolyol content in the polyol component can be increased to about 50 pph based on the total polyol content, in combination with the HMW synthetic polyol having the prescribed molecular weight and functionality.

The HMW synthetic polyol which is combined with the castor oil or soy oil biopolyol has a molecular weight within a range of about 4500 to about 6500, with an average functionality typically about 2 or above. In an embodiment, the average functionality is in the range of about 2 to about 5. Preferably, the average functionality is in the range of 2.5 to 3.0 As a result, the HMW synthetic polyol has an equivalent weight in the range of about 1500 to about 2500. In another embodiment, the equivalent weight is in the range of about 1600 to about 2000. As used herein, the molecular weight of the polyol is derived from a calculation based on the hydroxyl value of the individual polyol. In another embodiment, molecular weight range limits for the synthetic polyol can be as broad as about 3500 to about 15000. Alternatively, the synthetic polyol molecular weight range can be about 4000 to 14500, or about 4500 to 14000, or about 5000 to 13500, or about 5500 to 13000, or about 6000 to 12500, or about 6500 to 12000, or about 7000 to about 11500, or about 7500 to 11000, or about 8000 to 10500, or about 8500 to about 10000, or about 9000 to 9500.

Alternatively, the molecular weight range for the HMW synthetic polyol, which is combined with castor polyol, is about 4600 to about 6400, or about 4800 to about 6200, or about 5000 to about 6000, or about 5200 to about 5800, or about 5400 to about 5600. Alternatively, the HMW synthetic polyol molecular weight range can be about 4600 to about 5000, or about 4700 to about 5000, or about 4800 to about 5000. Alternatively, the HMW synthetic polyol molecular weight is about 5000, or about 4900, or about 5100, or about 4800, or about 5200.

The HMW synthetic polyol preferably incorporates a high percentage of ethoxylation (EO addition) measured as weight percent EO of the total epoxide used (EO and PO) to make the polyol. The preferred weight percentage of EO addition is in the range of about 65% to about 75% of the total epoxide added to make the polyol, preferably about 68% to about 72%. The level of propoxylation constitutes up to the remainder percentage from 100%, after the EO content is subtracted out. A polyol can be characterized as a polyether polyol, or for example, alternatively a polyester polyol or polyamine polyol, or yet other polyols. For use in the making of a flexible foam, the predominant polyol material is polyether polyol. Castor oil, for example, is more specifically characterized as an alkane triol. If all three of the soy oil carbonyl groups are converted to hydroxyl groups, that soy molecule would also be an alkane triol. If two or only one carbonyl group is converted, the soy molecule is an alkene diol or monol, respectively.

### BRIEF DESCRIPTION OF THE DRAWINGS

FIG. 1 is a schematic illustration of a continuous, free-rise polyurethane foam processing apparatus;

FIG. 2 is a schematic illustration of a box-pour machine for polyurethane foam.

FIG. 3 is a photograph depicting foam buns AX through HX produced from the formulas set out in Table 3.

### DETAILED DESCRIPTION OF THE INVENTION

The Invention in its broader aspects relates to a polyol composition for producing flexible polyurethane (PU) foams which combines a portion of HMW synthetic polyol with a portion of a biopolyol derived from plant sources. The biopolyol obtained from one or more plant sources is considered a renewable, or sustainable, product. Examples of plant-derived polyols include castor oil and soy oil. Castor oil is characterized as an alkane triol. Soy oil may be a monol, a diol, or a triol depending on the reaction conditions. Other natural oils with more than one hydroxyl group per molecule can also function as a source for natural oils, natural polyols and polyols derived from natural oils used to produce polyols for making PU foams. Herein, the polyols of interest include at least a portion of a plant-based renewable polyol.

The invention relates to polyol compositions comprising at least a portion of a polyol from a renewable or sustainable source. As used herein, the terms “renewable” and “sustainable” are employed interchangeably. The invention also comprises the PU foams prepared from a polyol component which includes a sustainably-sourced polyol. The invention also relates to methods for making PU foams containing a sustainably-sourced polyol.

In further detail, the invention relates to a polyol composition comprising from about 15 pph by weight up to about 50 pph by weight (of the total polyol component) of a sustainably sourced biopolyol produced from castor oil or soy oil. This biopolyol is then combined with a HMW synthetic polyol derived from a petroleum source to produce a polyol component for making a PU foam. In one embodiment the weight percentage of the biopolyol is equal to the weight percentage of the HMW synthetic polyol. In another embodiment, the relative ratios of biopolyol to HMW synthetic polyol span from 30:70 to 70:30 by weight. In another embodiment the range spans from 40:60 to 60:40 by weight. In another embodiment the range spans from 20:80 to 80:20 by weight.

The HMW synthetic polyol has an equivalent weight between about 1500 to about 2500. The equivalent weight is the molecular weight divided by the average functionality (hydroxyl groups capable of reacting with isocyanate.) In another embodiment, the equivalent weight is in the range of about 1600 to about 2000.

Preferably the biopolyol from castor oil or modified soy oil does not contain added ethoxylation or propoxylation chemically incorporated into the molecule backbone by reaction, though some level of added ethoxylation or propoxylation to the biopolyol is possible.

To produce a synthetic polyol, such as a polyether polyol, an initiator is combined with ethylene oxide and/or propylene oxide to varying degrees of alkoxylation as desired. Without limitation, the initiator can be glycerin, sucrose, trimethylolpropane, triethanolamine, ethylene diamine, or a functional initiator (including glycerin) with partial alkoxylation, such as alkylene oxide, adducts of glycerin, trimethylolpropane, triethanolamine, 1,2,6-hexane triol, monethanolamine, diethanolamine, and amino ethylpiperazine, and polyols made thereof.

The castor oil polyol has the following chemical structure:

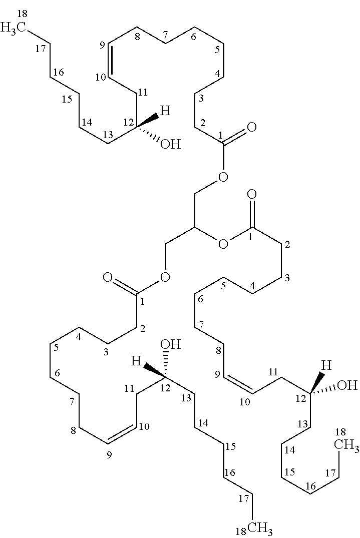 [SMILES: CCCCCC[C@@H](O)C/C=C\CCCCCCCC(=O)OCC(COC(=O)CCCCCCC/C=C\C[C@H](O)CCCCCC)OC(=O)CCCCCCC/C=C\C[C@H](O)CCCCCC]

The starting soy oil molecule has the following chemical structure:

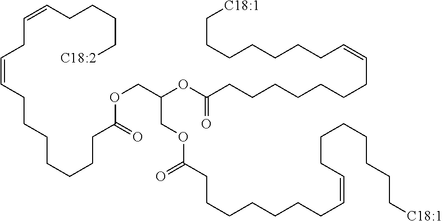

The isocyanate component can be difunctional, or alternatively have three or more functionalities. Difunctional isocyanates include but are not limited to 2,4-toluene diisocyanate (2,4-TDI), 2,6-toluene diisocyanate (2,6-TDI), m-phenylene diisocyanate, p-phenylene diisocyanate, 4,4′-diphenylmethane diisocyanate (4,4′-MDI), 2,4′-diphenylmethane diisocyanate (2,4′-MDI), 2,2′-diphenylmethane diisocyanate (2,2′-MDI), xylylene diisocyanate, and 3,3′-dimethyl-4,4′-biphenylene. Further examples of such diisocyanates include aromatic diisocyanates such as 3,3′-dimethoxy-4,4′-biphenylene diisocyanate, alicyclic diisocyanates such as cyclohexane-1,4-diisocyanate, isophorone diisocyanate, dicyclohexylmethane-4,4′-diisocyanate and methylcyclohexane diisocyanate, and aromatic diisocyanates such as butane-1,4-diisocyanate, hexamethylene diisocyanate, isopropylene diisocyanate, methylene diisocyanate and lysine diisocyanate. As shown above, both aromatic and non-aromatic diisocyanates can be used.

Isocyanates with three or more functionalities include 1-methylbenzene-2,4,6-triisocyanate, 1,3,5-trimethylbenzene-2,4,6-triisocyanate, biphenyl-2,4,4′-triisocyanate, diphenylmethane-2,4,4′-triisocyanate, methyldiphenylmethane-4,6,4′-triisocyanate, 4,4′-dimethyldiphenylmethane-2,2′,5,5′-tetraisocyanate, and triphenylmethane-4,4′,4″-triisocyanate.

Reaction of the castor polyol with an isocyanate occurs at one or more of the (—OH) substituents on the castor polyol molecule. The soy oil molecule shown above cannot in its natural form be reacted with an isocyanate to produce a polyurethane polymer. At least one double-bonded oxygen on the molecule at a carbonyl group on the carbon chain must be converted to a hydroxyl group to render the soy oil molecule active for reaction with the isocyanate.

To better control the reaction rate between polyol and isocyanate, one or more catalysts may be employed. Reaction may proceed in the absence of a catalyst, but introducing catalyst permits adjustment of the reaction rate with potentially further control of the final properties of the foam.

Flexible PU foam chemistry particularly features two reactions—the blowing reaction and the gelation reaction. To achieve a foam with a stable open-cell structure and good physical properties, there needs to be a balance between the blowing and gelation reactions. Failure to adequately control these two reactions can lead to formation of an unacceptable foam product. Specifically, the foam can collapse, the cell structure can have serious internal imperfections, and the cells comprising the foam may open either too soon, or not at all. To better control these two reaction sequences, it is desired to use catalysts. Suitable catalysts serve to better control the speed and relative rates of the foam reactions. Typical catalysts are selected from two major classes of compounds: tertiary amines and metal salts, generally salts containing tin, though other catalysts may be employed.

Catalysts which can facilitate this reaction include but are not limited to amine catalysts such as bis(2-dimethylamino)ethylether, trimethylamine, triethylamine, triethylenediamine, tetramethylguanidine, heterocyclic amines such as N-alkylmorpholines (N-methylmorpholine, N-ethylmorpholine, and the like), 1,4-dimethyl piperazine, triethylenediamine and the like, and aliphatic polyamines. Other catalysts include tin catalysts such as dibutyltin dilaurate, dibutyltin diacetate, diethyltin diacetate, dioctyltin dioxide, stannous octoate, stannous oleate, tin salts of neodecanoic acid, and the like; and metal catalysts (also called organometallic catalysts) such as phenylmercury propionate and lead octenate.

Other additives or components for use in facilitating PU foam formation include blowing agents such as water, acetone, pentane, methyl acetate, halogenated low-boiling hydrocarbons including trichloromonofluoromethane, methylene chloride, nitrogen, and carbon dioxide.

PU foam production relies on the incorporation of silicone-containing surfactants to accomplish a range of needs within the polymer reaction zone. The surfactant, which is non-ionic, is used to reduce surface tension in the reaction mixture, to emulsify incompatible ingredients, to promote bubble nucleation during reactant mixing, and to counter or reduce the defoaming effect of any solids added to the reaction mixture.

The concentration of the surfactant is determined by the final properties desired for the foam, and by the specific type of surfactant used. Typically, the surfactant concentration is in the range of about 0.5 to about 2.5 pph (parts per hundred) polyol. Insufficient surfactant can result in failure of the polymer to form a stable cellular structure. Excess surfactant usage can cause formation of closed foam cells, which decreases the airflow through the foam. A higher degree of closed cells can lead to foam shrinkage upon cooling.

Representative examples of surfactants for use in the making of flexible PU foam include but are not limited to low viscosity siloxane oils based on poly(dimethylsiloxane), and graft copolymers of polysiloxane-polyoxyalkylene.

Other additives may be incorporated into the reactant mixture to address certain performance requirements for the final foam. Thus, one or more of the following additives may be included in the foam: cross-linking agents; flame retardants; UV stabilizers; bacteriostats; plasticizers; antistatic agents; extender oils; dyes; pigments; and antimicrobial compounds.

In one process for producing flexible PU foam, the flexible foam is made on a continuous machine (“pour-line”), wherein all of the components of a foam formulation are metered (pumped at known rates) into a flow-through mixing chamber. The foam components (all polyols, additives, catalysts, water, isocyanate(s), etc.) leave the mixing chamber and are guided by flexible hose(s) into an open-top trough, which acts to provide some residence time (typically 12-22 seconds), before the frothing mix flows out onto a wide moving film and down a conveyor. As needed to facilitate the foam processing, the polyol and isocyanate streams can have heating or cooling controls to maintain the desired temperature(s) for processing.

Other processes and/or equipment for producing foams include “direct lay-down” machines whereby the reacting liquids do not go through a trough, and are instead poured directly on a moving film over a “pour-board”. There are continuous vertical foam machines where the liquid is pumped into the bottom of an expansion chamber, and the resulting foam is gently pulled upward by means of a 4-sided conveyor system with pins that is lined with film. Another common foam production system is a batch process box foam machine. With this type of foam machine, the chemical components for foam are added to a mixing can, mixed, and then poured or dumped into a box or mold. There are machines designed to use CO₂ as an auxiliary blowing agent, where the foam chemicals are mixed in a high pressure chamber to control the expansion of CO₂, and the liquid mixture is passed through a pressure let-down device (one of several designs including a gate-bar and a screen-pack creamer bell) onto a moving film conveyor to produce continuous CO₂-blown polyurethane flexible foam.

As one embodiment of the invention, the correct ratio of polyols, including castor and HMW synthetic polyol, can be metered separately into the mixing chamber to make foam. As one option, the castor and HMW synthetic polyol would be premixed in a tank and supplied to customers via tank trucks, ISO containers, drums, totes and the like. The customer would treat the blend as a single polyol, which would be metered to the mixing chamber along with other necessary components of a desired foam formulation to make continuous foam. The isocyanate would be added during the foaming process in a continuous manner.

To produce a PU foam from polyol and isocyanate, one preparatory method combines the biopolyol and HMW synthetic polyol into a polyol blend. The blend is then further treated with one or more additives used to modify the working and final properties of the foam formed after reaction with the isocyanate. The additives can include, but are not limited to, one or more of a surfactant, catalyst, blowing agent, cross-linking agent, flame retardant, UV stabilizer, bacteriostat, plasticizer, and antistatic agent. Though these additives are identified in the singular, more than one of each such additive can be incorporated into the polyol and the foam final product, as the circumstances require. Solid additives are typically blended with one or more of the polyol components. Liquid additives are metered into the mixing chamber separately. In an optional arrangement, water can be introduced to the mixing-head directly.

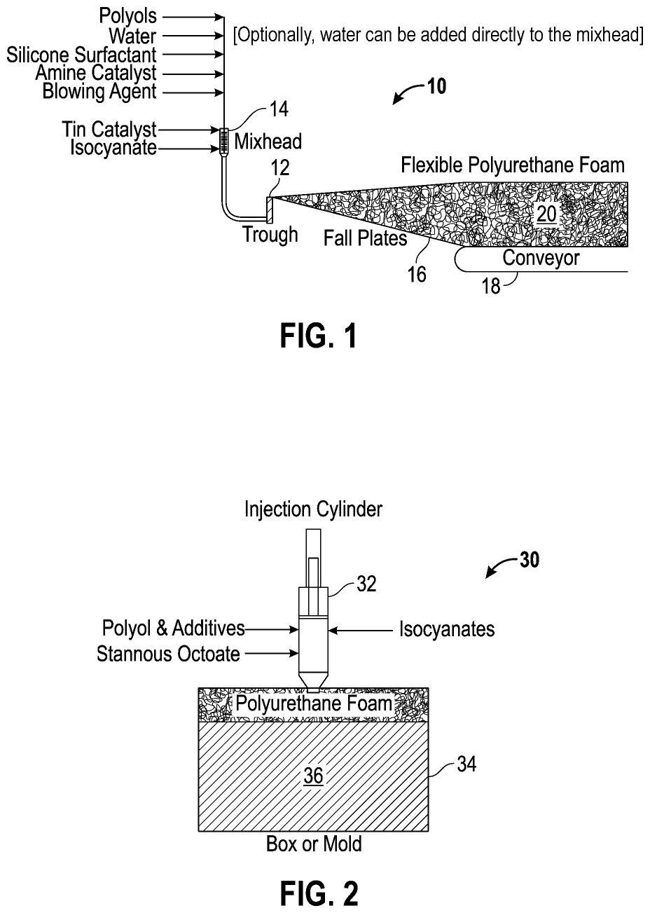

As defined herein, the term polyurethane foam means polyether-based polyurethane foam or polyester-based polyurethane foam or a combination polyether and polyester polyurethane foam. As noted, polyurethane foam is commonly produced by methods of molding and free-rise. A common design for continuous free-rise processing equipment is the MAXFOAM machine. This type of machine, schematically illustrated in FIG. 1, uses a trough 12 where the chemicals are first introduced from a mixing head 14. The foam chemicals (including, but not necessarily limited to polyol(s), water, silicone surfactant, catalyst, blowing agent(s), and isocyanate) stay in the trough 12 for about 10 to 25 seconds and then spill over the trough lip onto a series of fall-plates 16 leading to the main conveyor 18. The fall-plates 16, side-walls (not shown) and conveyor(s) 18 are protected from the reacting foam chemicals by a continuous film feed (bottom film, side films and additional films for block shaping; not shown in FIG. 1). Flexible polyurethane foam 20 is continuously produced by this technique.

Another common method of producing free-rise flexible foam is with a box-pour machine 30, as schematically illustrated in FIG. 2. This is a batch process whereby the foam chemicals are mixed and introduced in a variety of methods. These methods include but are not limited to the following: a mix-head or injection cylinder 32 using metered chemicals, manual or automatic addition by weight, reaction-injection-molding (RIM) and injection cylinders are known methods of introducing the chemicals into a container 34 (box, mold or cylinder). The containers are typically lined with cardboard or plastic film to facilitate removal of the foam 36.

The flexible polyurethane foam described herein may be produced under pressure or under vacuum using batch processes or continuous processes. Producing foam under pressure or vacuum refers to the air-space around the foam during the foaming reaction. For pressure or vacuum foaming, the machine is inside a pressure chamber. In the case of a continuous variable pressure foam machine, the pressure chamber is a long tunnel that begins at the point where the liquid is introduced either to a trough or directly onto the conveyor and continues to the point where the foam has fully risen and is cured enough to hold its form when the vacuum or pressure is released. For continuous foam production, the pressure controlled chamber is typically in the range of 100 to 200 ft in length. Alternatively, vacuum or pressure foaming can be accomplished using a batch process, where a box machine or other batch foam process is within a pressure controlled chamber. In another design, a pressure controlled chamber encloses a vertical foam machine.

Alternatively, the method is practiced under atmospheric pressure, in the regime of atmospheric pressure to greater than atmospheric pressure, or in the regime of atmospheric pressure to less than atmospheric pressure. The process may be a free rise process or may involve a mold as previously described.

To demonstrate the ability of the combined polyol from castor polyol and HMW synthetic polyol to produce acceptable flexible foam products at higher levels of castor polyol concentration and thus higher levels of sustainable content in the flexible foam product, various combinations of polyol components were reacted with an isocyanate, then evaluated using various standardized ASTM tests. Flexible PU foams with higher levels of sustainable content can also be prepared using modified soy oil as a polyol component.

Table 1, below, sets out a number of different foam formulations for one type of foam product for ultimate use in specialty applications.

TABLE 1

| Sample: | | A | B | C | D | E | F | G | H | I | J | K | L |
|---|---|---|---|---|---|---|---|---|---|---|---|---|---|
| Polyol | 1000 mw | 75 | 70 | 65 | 60 | 55 | 50 | 45 | 75 | 65 | 55 | 45 | 35 |
| (pph) | 3500 mw | 25 | 25 | 25 | 25 | 25 | 25 | 25 | 25 | 25 | 25 | 25 | 25 |
| | graft | | | | | | | | | | | | |
| | High mw | — | — | — | — | — | — | — | — | 5 | 10 | 15 | 20 |
| | Castor | — | 5 | 10 | 15 | 20 | 25 | 30 | — | 5 | 10 | 15 | 20 |
| | polyol | | | | | | | | | | | | |

| | | | | | | | | | | | | |
|---|---|---|---|---|---|---|---|---|---|---|---|---|
| (pph) Isocyanate (MDI) | 48.1 | 48.2 | 48.1 | 48.1 | 48.0 | 48.1 | 48.1 | 47.9 | 47.9 | 48.2 | 48.6 | 49.4 |
| Water (%) | 2.1 | 2.1 | 2.1 | 2.1 | 2.1 | 2.1 | 2.1 | 2.0 | 2.1 | 2.1 | 2.1 | 2.1 |
| Amine Catalyst (%) | 0.28 | 0.28 | 0.28 | 0.28 | 0.28 | 0.28 | 0.28 | 0.28 | 0.28 | 0.28 | 0.28 | 0.28 |
| Silicone Surfactant (%) | 0.9 | 0.9 | 0.9 | 0.9 | 0.9 | 0.9 | 0.9 | 0.9 | 0.9 | 0.9 | 0.9 | 0.9 |
| Tin Catalyst (%) | 0.10 | 0.10 | 0.10 | 0.10 | 0.10 | 0.10 | 0.10 | 0.10 | 0.10 | 0.10 | 0.10 | 0.10 |
| Tests: ASTM D3574, | 3.35 | 3.20 | 3.09 | 3.51 | 3.29 | Unusable | Unusable | 3.40 | 3.26 | 3.05 | 3.08 | 2.95 |
| Test A¹ | | | | | | Foam | Foam | | | | | |
| ASTM D3574, Test B² | 26.3 | 20.5 | 13.7 | 11.7 | 5.6 | | | 25.6 | 22.2 | 18.7 | 19.8 | 12.0 |
| ASTM D3574, Test G′³ | 2.6 | 3.5 | 3.9 | 4.0 | 4.8 | | | 2.9 | 3.8 | 4.2 | 4.3 | 5.5 |
| ASTM D3574, Test D⁴ | 0.3 | 0.5 | 1.3 | 6.4 | 85.9 | | | 0.6 | 2.2 | 2.8 | 4.9 | 11.8 |
| Notes: | Control | | Softer | Very | Very | Severe | Severe | Control | Similar | Similar | Similar | Soft, |

| | | | | | | | | |
|---|---|---|---|---|---|---|---|---|
| than | soft | soft | shrinkage | shrinkage - | to | to | to | No |
| Control | and | and | | unusable | control | control | control | shrink- |
| | slight | moderate | | foam | | | | age |
| | shrinkage | shrinkage | | | | | | |

¹Density (lb/ft³)
²Indentation Force Deflection (lb/50 in²)
³Air Flow Crushed (SCFM)
⁴90% Compression Set (Height Loss in %)

In reference to the collected test data for the samples in Table 1, Samples A through H contained no high MW polyol, which for the rest of the series was Multranol 9199 from Covestro (CAS number 9082-00-2). Multranol 9199 is a 4550 MW polyether polyol modified with ethylene oxide, with an equivalent weight of 1500. The —OH number was within the specification range of 35-39. The catalyst is an amine catalyst, such as ZF-10 from Huntsman Chemical Co. A silicone surfactant is included, such as L-618 from Momentive. SO Tin Catalyst from Gulbrandsen was also used.

The ASTM test results for samples A-C show slight deterioration moving from A to C in IFD, air flow, and recovery rate with increasing castor polyol percentage in the polyol component, up to 10 pph. Air flow crushed values slightly improved from A through C. At 15 pph castor in the polyol (Sample D), IFD continued to deteriorate in an essentially linear fashion from sample A in the series. But, the recovery rate and 90% compression set values deteriorated more substantially, in a significantly non-linear fashion, for samples C and D, at 10 and 15 pph castor oil content respectively. At 20 pph castor oil content in sample E, the 90% compression set value deteriorated significantly. The recovery rate test could not even be run. At 25 and 30 pph castor in Samples F and G, none of the ASTM tests could be run.

Considering the ASTM test results for samples H-L which contained high MW polyol in combination with castor oil, the 1000 MW polyol pph value was incrementally lowered over the series, from 75 pph polyol to 35 pph polyol. The 3500 MW graft copolymer component concentration was maintained at a constant 25 pph level across the series, as was done for samples A-G. The castor polyol concentration, beginning at 0 pph, was again regularly increased, from 5 pph to 20 pph in 5 pph increments. The high MW polyol, Multranol 9199 from Covestro, was incorporated at increasing levels, at the same pph concentration as castor polyol.

Considering the ASTM test results for samples H-L, over the range of castor polyol concentration and Multranol 91990 polyol from 0 pph up to 20 pph, very little change was observed in density, air flow, and air flow crushed values. A linear change was observed in IFD over this series, but even at the 20 pph castor polyol concentration the foam product was still considered to be commercially useful. Also, the 90% compression set values, though increasing with increased castor polyol content, were still commercially feasible.

The following samples in Table 2, AA through AH, were prepared using a different flexible foam polyol/isocyanate combination. This foam would typically have use in commodity applications.

TABLE 2

| Conventional Foam | | | | | | Conventional Foam | | | |
|---|---|---|---|---|---|---|---|---|---|
| | Sample ID Number | AA | AB | AC | AD | AE | AF | AG | AH |
| Polyols | 3000 MW polyether | 100 | 95 | 90 | 85 | 100 | 80 | 70 | 60 |
| | triol | | | | | | | | |
| | M-9199 | | | | | | 10 | 15 | 20 |
| | BP-164 Castor Polyol | | 5 | 10 | 15 | | 10 | 15 | 20 |
| Isocyanates | TDI | 40.9 | 42.8 | 43.9 | 45.0 | 41.1 | 42.6 | 43.4 | 44.2 |
| | Water | 3.1 | 3.1 | 3.1 | 3.1 | 3.1 | 3.1 | 3.1 | 3.1 |
| | ZF-10 Amine Cat. | 0.05 | 0.05 | 0.05 | 0.05 | 0.05 | 0.05 | 0.05 | 0.05 |
| | RE-533 Amine Cat. | 0.05 | 0.05 | 0.05 | 0.05 | 0.05 | 0.05 | 0.05 | 0.05 |
| | DC-5986 Surfactant | 0.9 | 0.9 | 0.9 | 0.9 | 0.9 | 0.9 | 0.9 | 0.9 |
| | 100% So Tin Catalyst | 0.20 | 0.26 | 0.29 | 0.32 | 0.20 | 0.24 | 0.29 | 0.35 |
| Foam | ASTM D3574, Test A⁵ | 1.75 | | 1.71 | 1.76 | 1.75 | 1.76 | 1.74 | 1.72 |
| Properties | ASTM D3574, Test B⁶ | 22.6 | | 24.1 | 32.8 | 30.2 | 29.1 | 32.0 | 33.9 |
| | ASTM D3574, Test G⁷ | 6.3 | | 6.8 | 7.0 | 3.4 | 4.3 | 3.4 | 2.9 |
| | ASTM D3574, Test G′⁸ | 6.5 | | 7.1 | 7.6 | 3.4 | 4.4 | 3.3 | 2.8 |
| | ASTM D3574, Test D⁹ | 10.3 | | 8.4 | 24.6 | 10.9 | 7.5 | 10.2 | 12.3 |
| | Notes | Control | | Similar to | 45% increase | Control | Similar to | Similar to | Similar to |
| | | | | control | in IFD and | | control | control | control |
| | | | | | failed | | | | |
| | | | | | compression | | | | |
| | | | | | sets | | | | |

⁵Density (lb/ft³)
⁶Indentation Force Deflection (lb/50 in²)
⁷Air Flow (SCFM)
⁸Air Flow Crushed (SCFM)
⁹90% Compression Set (Height Loss in %)

With reference to Table 2, the polyether triol has a relatively high molecular weight of about 3000, with a hydroxyl value of about 56. A representative material is a polyester triol, such as BASF Pluracol 4156. It is glycerinp based, with about 90% PO and 10% EO content. The compositions in AF-AH contained Covestro M-9199, a HMW synthetic polyol produced with a high percentage of ethylene oxide, in combination with the castor polyol. The molecular weight of M-9199 is about 4550, with an equivalent weight of 1500.

The biopolyol for this series was castor polyol. The isocyanate employed in making the foam was TDI-80. An amine catalyst was used in producing the foam, such as ZF-10 from Huntsman. A silicone surfactant was used in producing the foam, in this instance DC-5986 from Dow Chemical. A second amine catalyst was also incorporated into the reactant mixture, Dabco RE-533 from Air Products. This is a gel-amine catalyst.

Samples AA-AD are directed to formulas using castor polyol, but without the inclusion of a high molecular weight polyol (HMW synthetic polyol). As the castor polyol content increased, though several test results remained generally constant (density, air flow, air flow crushed) the IFD test results showed a generally linear increase in the series of increasing castor polyol levels. The 90% compression set data showed an exponential deterioration at 15 pph castor polyol content. Low percentage height loss predicts the ability of the foam to recover dimensionally from compressed packaging.

In contrast, the PU foam formulas containing increasing amounts of castor polyol with a matching amount of the Covestro M-9199 polyether triol (AE-AH) showed little change in test results for all categories of ASTM D3574 test results, including the 90% compression set.

The last formula in this series, AH, produced test results similar to those found with control formula (AE) even at a castor polyol concentration of 20 pph.

The following samples in Table 3, AX-HX, were prepared using a different flexible foam polyol/isocyanate combination. This foam would typically have use in commodity foam applications.

TABLE 3

| Conventional Foam | | | | | | Conventional Foam | | | |
|---|---|---|---|---|---|---|---|---|---|
| | Sample ID Number | AX | BX | CX | DX | EX | FX | GX | HX |
| Polyols | Pluracol 4156 | 100 | 90 | 80 | 70 | 100 | 80 | 60 | 40 |
| | M-9199 | | | | | | 10 | 20 | 30 |
| | BP-164 Castor Polyol | | 10 | 20 | 30 | | 10 | 20 | 30 |
| Isocyanates | TDI-80 | 43.8 | 45.7 | 47.6 | 49.5 | 43.8 | 45.4 | 47.0 | 48.6 |
| | Total Water | 3.4 | 3.4 | 3.4 | 3.4 | 3.4 | 3.4 | 3.4 | 3.4 |
| | ZF-10 Amine Catalyst | 0.05 | 0.05 | 0.05 | 0.05 | 0.05 | 0.05 | 0.05 | 0.05 |
| | RE-533 Aine Catalyst | 0.05 | 0.05 | 0.05 | 0.05 | 0.05 | 0.05 | 0.05 | 0.05 |
| | DC-5986 Silicone Surfactant | 0.9 | 0.9 | 0.9 | 0.9 | 0.9 | 0.9 | 0.9 | 0.9 |
| | TCat 110 Stannous Octoate | 0.15 | 0.15 | 0.15 | 0.15 | 0.15 | 0.20 | 0.25 | 0.30 |
| | Catalyst | | | | | | | | |
| Reactivity | Full Rise Time | 160 | 203 | 242 | 274 | 156 | 163 | 162 | 161 |
| Foam | ASTM D3574, Test A¹⁰ | 1.89 | 1.85 | 1.87 | | 1.83 | 1.73 | 1.79 | 1.78 |
| Properties | ASTM D3574, Test B¹¹ | 37.3 | 31.9 | 21.8 | | 38.6 | 32.9 | 34.6 | 36.4 |
| | ASTM D3574, Test G¹² | 4.6 | 7.4 | 7.7 | | 4.2 | 3.0 | 3.0 | 2.6 |
| | ASTM D3574, Test D¹³ | 9.4 | 7.2 | 87.6 | | 8.9 | 12.2 | 15.4 | 8.4 |
| | Notes | Control | Similar | Stiff, high | Foam | Control | Similar | Similar | Similar |
| | | | to | compression | collapsed - | | to | to | to |
| | | | control | set loss | Unusable | | control | control | control |

¹⁰Density (lb/ft³)
¹¹Indentation Force Deflection (lb/50 in²)
¹²Air Flow Crushed (SCFM)
¹³90% Compression Set (Height Loss in %)

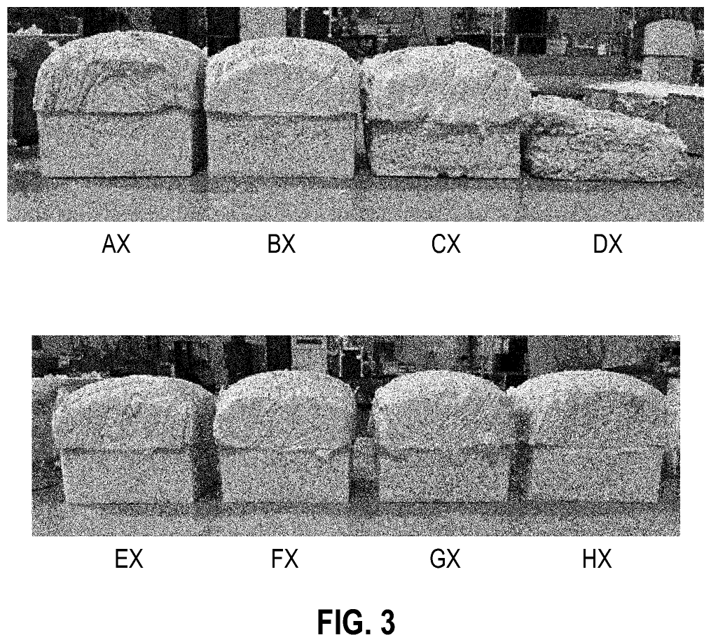

The following samples identified in Table 3, AX through HX, were prepared using a different PU foam formula. Similar to the series in Table 2, the foam products would typically have use in commodity applications. The identified foam buns in FIG. 3 correspond to the formulations from Table 3. Distinct from the series shown in Tables 1 and 2, the Table 3 also series shows the full rise time value for the various formulas. Distinct also from the series shown in Tables 1 and 2, the isocyanate was TD1-80. And, the stannous octoate catalyst was T-Cat 110 from Gulbrandsen Chemical.

Considering samples AX-DX, the full rise time increased generally linearly, from 160 sec to 274 sec at increasing castor polyol levels. At a castor polyol level of 30 pph in sample DX, no ASTM testing could be run. In FIG. 3 it can be seen that the DX foam pillow was less than half the height of the CX sample, and the CX sample was showing some signs of foam collapse.

In contrast, the EX-HX samples showed little ASTM test result changes, where M-9199 copolyol of equal weight to the castor polyol was incorporated into the formulations. The foam buns in FIG. 3 also show little physical difference among each of the buns.

Although the invention has been disclosed in the context of certain embodiments, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein, but instead that it includes all modifications and alternatives coming within the true scope and spirit of the invention as embodied in the attached claims.

1. A polyol composition for forming polyurethane foam, the polyol composition comprising:
about 15% (wt) to about 50% (wt) of the total polyol content by weight of a biopolyol; and
a high molecular weight synthetic polyol within a molecular weight range of about 4500 to about 6500.

2. The polyol composition of claim 1 wherein the biopolyol is sourced from castor oil or soy oil.

3. The polyol composition of claim 1 wherein the weight ratios of biopolyol to high molecular weight synthetic polyol span from 30:70 to 70:30.

4. The polyol composition of claim 1 wherein the weight ratios of biopolyol to high molecular weight synthetic polyol span from 40:60 to 60:40.

5. The polyol composition of claim 1 wherein the weight ratios of biopolyol to high molecular weight synthetic polyol span from 20:80 to 80:20.

6. The polyol composition of claim 2 wherein the biopolyol does not contain added ethoxylation or propoxylation incorporated into a backbone of the biopolyol by reaction.

7. The polyol of claim 2 wherein the castor oil is a polyol with an approximate molecular weight of about 1000 and a functionality of about 3.

8. A composition for producing polyurethane foam comprising:
an isocyanate;
a polyol comprising about 15% (wt) to about 50% (wt) of the total polyol content by weight of a biopolyol sourced from castor oil or soy oil,
a high molecular weight synthetic polyol with a molecular weight range of about 4500 to about 6500; and
a catalyst.

9. The composition of claim 8 wherein the catalyst is selected from the group consisting of bis(2-dimethylamino)ethylether, trimethylamine, triethylamine, triethylenediamine, tetramethyl guanidine, heterocyclic amines, 1,4-dimethyl piperazine, triethylenediamine, aliphatic polyamines, dibutyltin dilaurate, dibutyltin diacetate, diethyltin diacetate, dioctyltin dioxide, stannous octoate, stannous oleate, tin salts of neodecanoic acid, phenyl-mercury propionate, and lead octenate.

10. The composition of claim 8 further comprising one or more cross-linking agents, flame retardants, UV stabilizers, bacteriostats, plasticizers, antistatic agents, extender oils, dyes, pigments, and antimicrobial compounds.

11. The composition of claim 8 wherein the polyurethane foam is flexible.

12. The composition of claim 8 wherein the isocyanate is selected from the group consisting of 2,4-toluene diisocyanate, 2,6-toluene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, xylylene diisocyanate, 3,3′-dimethoxy-4,4′-biphenylene diisocyanate, cyclohexane-1,4-diisocyanate, isophorone diisocyanate, dicyclohexylmethane-4,4′-diisocyanate, methylcyclohexane diisocyanate, butane-1,4-diisocyanate, hexamethylene diisocyanate, isopropylene diisocyanate, methylene diisocyanate, lysine diisocyanate, 1-methylbenzene-2,4,6-triisocyanate, 1,3,5-trimethylbenzene-2,4,6-triisocyanate, biphenyl-2,4,4′-triisocyanate, diphenylmethane-2,4,4′-triisocyanate, methyldiphenylmethane-4,6,4′-triisocyanate, 4,4′-dimethyldiphenylmethane-2,2′,5,5′-tetraisocyanate, and triphenylmethane-4,4′,4″-triisocyanate.

13. The composition of claim 8 further comprising a blowing agent.

14. The composition of claim 13 wherein the blowing agent is selected from the group consisting of water, acetone, pentane, methyl acetate, trichloromonofluoromethane, methylene chloride, nitrogen, and carbon dioxide.

15. The composition of claim 8 further comprising a non-ionic silicone-containing surfactant.
